(19) United States
(12) Patent Application Publication
(10) Pub. No.: US 2012/0294170 A1
(43) Pub. Date: Nov. 22, 2012

(54) METHOD FOR TRANSMITTING FRAME WITH INTERFERENCE AVOIDANCE IN WIRELESS LOCAL AREA NETWORK SYSTEM AND APPRATUS FOR THE SAME

(75) Inventors: Heejung YU, Daejeon-si (KR); Hun Sik Kang, Daejeon-si (KR); Sok Kyu Lee, Daejeon-si (KR)

(73) Assignee: Electronics and Telecommunications Research Institute, Daejeon (KR)

(21) Appl. No.: 13/413,961

(22) Filed: Mar. 7, 2012

(30) Foreign Application Priority Data
May 16, 2011 (KR) 10-2011-0045577

(51) Int. Cl. H04W 24/00; H04W 84/12

(52) U.S. Cl. 370/252; 370/338

(57) ABSTRACT

A method for transmitting a frame in a wireless local area network system is provided. The method includes obtaining, by a station (STA), interference channel information of an interference channel between the STA and neighbor STA that is a frame transmission object of an access point (AP); determining, by the STA, a transmitting beam vector based on the interference channel information; and transmitting, by the STA, a data frame to a transmission target STA using a multiple input multiple output (MIMO) transmission based on the transmitting beam vector.

### CROSS-REFERENCE TO RELATED APPLICATIONS

This application claims the benefit of priority of Korean Patent Application No. 10-2011-0045577 filed on May 16, 2011, which is incorporated by reference in their entirety herein.

### BACKGROUND OF THE INVENTION

1. Field of the Invention

The present invention relates to a wireless local area network system, and more particularly, to a method and an apparatus for transmitting a frame with interference avoidance in a wireless local area network system during transmission and reception of a frame performed by other stations.

2. Related Art

Recently, various wireless communication technologies have been developed with advancement of information communication technologies. Among others, a WLAN is a technology of wirelessly accessing the Internet in home, business, or specific service providing areas by using mobile terminals such as a personal digital assistant (PDA), a lap top computer, a portable multimedia player (PMP), or the like, based on a wireless frequency technology.

The WLAN system has been focused as a wireless communication technology providing a fast data service in an unlicensed band. In particular, unlike the existing cellular communication system, an access point (AP) serving as a base station can be easily installed by anybody when it is connected with a wired network including a distribution system and a power supply and is connected with a wired network and it is an inexpensive means to implement data communication. As a result, the access point has been prevalently used.

Institute of Electrical and Electronics Engineers (IEEE) 802 that is standards organization of WLAN technology established on February 1980 has perform many standard works. At the early stage, the WLAN technology supports a rate of 1 to 2 Mbps by frequency hopping using 2.4 GHz frequency, spread spectrum, infrared communication, or the like, based on IEEE 802.11. Recently, the WLAN technology can support a rate of a maximum of 54 Mbps based on IEEE 802.11g standard by using orthogonal frequency division multiplex (OFDM). In addition, IEEE 802.11 has practically used or developed standards of various technologies such as enhancement of quality for service (QoS), compatibility of access point (AP) protocol, security enhancement, radio resource measurement, wireless access vehicular environment, wireless access vehicular environment, fast roaming, mesh network, interworking with external network, wireless network management, or the like. Further, in order to overcome a limitation of communication rate indicated as vulnerability in the WLAN, there is IEEE 802.11n as a technology standard recently established. An object of the IEEE 802.11n is to increase rate and reliability of a network and extend an operating distance of the wireless network. More specifically, the IEEE 802.11n is based on multiple inputs and multiple outputs (MIMO) technology in which MIMO are used at both of a transmitting end and a receiving end in order to support a high throughput (HT) having a maximum data processing speed of 540 Mbps or more, minimize a transmission error, and optimize a data rate. In addition, the standard may use a coding scheme several duplicated copies in order to increase data reliability and may also use the orthogonal frequency division multiplex (OFDM) so as to increase data rate.

Meanwhile, the IEEE 802.11e standard supports a direct link setup (DLS) service of transmitting direct data between STAs without passing through the AP. The DLS service sets a direct link (DL) between a DLS initiator STA and a DLS responder STA and then, directly transmits/receives a data frame through the direct link. A detailed matter of the DLS service may be referred to sections 7.4.3 and 10.3.25 of ‘IEEE Standard for Information technology—Telecommunications and information exchange between systems—Local and metropolitan area networks—Specific requirements, Part 11 Wireless LAN Medium Access Control (MAC) and Physical Layer (PHY) Specifications’ disclosed in June, 2007.

When the AP and/or the STA access and use the channel in the WLAN system, other APs and/or STAs cannot originally access and use the corresponding channel. However, in order to more efficiently use wireless resources, a method for allowing other APs and/or STAs to use the corresponding channel while a specific AP and/or SPA use the channel for transmitting and receiving a frame has been proposed. To this end, a method for allowing the AP and/or the STA transmitting and receiving the data frame additionally using a co-channel to avoid interference or generate only very slight interference during the transmission and reception of frame conventionally performed has been proposed.

### SUMMARY OF THE INVENTION

The present invention provides a method and an apparatus for transmitting a frame with interference avoidance in a wireless local area network system during transmission and reception of a frame performed by other stations (STAs).

In an aspect, a method for transmitting a frame in a wireless local area network system is provided. The method includes: obtaining, by a station (STA), interference channel information of an interference channel between the STA and neighbor STA that is a frame transmission object of an access point (AP); determining, by the STA, a transmitting beam vector based on the interference channel information; and transmitting, by the STA, a data frame to a transmission target STA using a multiple input multiple output (MIMO) transmission based on the transmitting beam vector.

The step of the obtaining of the interference channel information between the STA and the neighbor STA may include: estimating, by the STA, the interference channel by receiving a clear to send frame (CTS frame) transmitted to inform the AP that the neighbor STA is ready to receive the frame.

The interference channel information may include an interference channel matrix G₂ that is a result of estimating the interference channel, and the interference channel matrix G₂ may satisfy the following Equation.

G₂v=0 (where v is the transmitting beam vector).

The step of the obtaining of the interference channel information between the neighbor STA and the STA may include: estimating, by the STA, the interference channel by receiving an acknowledgement frame (ACK frame) transmitted by the neighbor STA as a response to the frame transmitted by the AP

The interference channel information may include an interference channel matrix G₂ that is a result of estimating the interference channel, and the interference channel matrix G₂ may satisfy the following Equation.

G₂v=0 (where v is the transmitting beam vector).

In another aspect, a method for receiving a frame in a WLAN system is provide. The method includes: obtaining, by a station (STA), interference channel information of an interference channel between an AP and the STA; determining, by the STA, a receiving beam vector based on the interference channel information; and receiving, by the STA, a data frame transmitted from a transmitting STA, the data frame being transmitted through MIMO transmission, wherein the step of receiving the data frame includes applying beam vector to a wireless signal received by the STA.

The step of the obtaining the interference channel information between the AP and the STA may include: estimating, by the STA, the interference channel by receiving a request to send frame (RTS frame) transmitted to inform that the AP accesses the channel to transmit a frame.

The interference channel information may include an interference channel matrix g₁ that is a result of estimating the interference channel, and the interference channel matrix g₁ may satisfy the following Equation.

u^{H}g₁=0 (wherein u is the receiving beam vector and u^{H} is a vector obtained by performing complex conjugate transpose on the u).

The step of the obtaining the interference channel information between the AP and the STA may include: estimating, by the STA, the interference channel by receiving the frame transmitted by the AP to a neighbor STA, the neighbor STA being a transmission target STA of the AP.

The interference channel information may include an interference channel matrix g₁ that is a result of estimating the interference channel, and the interference channel matrix g₁ may satisfy the following Equation.

u^{H}g₁=0 (where u is the receiving beam vector and u^{H} is a vector obtained by performing complex conjugate transpose on the u).

In still another aspect, a wireless apparatus is provided. The wireless apparatus includes: a processor and a transceiver operatively connected with the processor to transmit and receive a frame. The processor is configured for: obtaining interference channel information of an interference channel between the STA and neighbor STA that is a frame transmission object of an access point (AP); determining a transmitting beam vector based on the interference channel information; and transmitting a data frame to a transmission target STA using a multiple input multiple output (MIMO) transmission based on the transmitting beam vector.

The obtaining the interference channel information may include: estimating the interference channel by receiving a clear to send frame (CTS frame) transmitted to inform the AP that the neighbor STA is ready to receive the frame.

The interference channel information may include an interference channel matrix G₂ that is a result of estimating the interference channel, and the interference channel matrix G₂ may satisfy the following Equation.

G₂v=0 (where v is the transmitting beam vector).

The obtaining the interference channel information may include: estimating the interference channel by receiving an acknowledgement frame (ACK frame) transmitted by the neighbor STA as a response to the frame transmitted by the AP

The interference channel information may include an interference channel matrix G₂ that is a result of estimating the interference channel, and the interference channel matrix G₂ may satisfy the following Equation.

G₂v=0 (where v is the transmitting beam vector).

### BRIEF DESCRIPTION OF THE DRAWINGS

FIG. 1 is a diagram showing an example of a WLAN system.

FIG. 2 is a message flow chart showing the transmission and reception of the RTS-CTS frame.

FIG. 3 is a diagram showing an example of the WLAN system that may be applied to the exemplary embodiment of the present invention.

FIG. 4 is a diagram showing an example of the communication system performing a downlink operation to which the exemplary embodiment of the present invention can be applied

FIG. 5 is a diagram showing the communication system performing an uplink operation to which the exemplary embodiment of the present invention can be applied.

FIG. 6 is a block diagram showing a wireless device to which the embodiment of the present invention may be applied.

### DESCRIPTION OF EXEMPLARY EMBODIMENTS

Hereinafter, exemplary embodiments of the present invention will be described in detail with reference to the accompanying drawings. An exemplary embodiment of the present invention to be described below may be usefully used when a WLAN system supporting a multi-user-multiple input multiple output (MU-MIMO) and/or a single user (SU)-MIMO and a WLAN system supporting a direct link setup (DLS) service coexist and may be applied to even the case in which the MU/SU-MIMO and the DLS service are provided in a single WLAN system. Although the WLAN system is described as an example, a technical idea of the present invention is not limited thereto.

Even when data transmission by the DLS service (hereinafter, referred to as direct link transmission) and another direct link transmission are simultaneously performed, an interference avoidance method proposed by the present invention may be identically applied. The direct link transmission, which is an example of inter-station communication, may be identically applied to a Wi-Fi Direct service, an Ad-hoc link service, and direct communication among other stations in addition to the Institute of Electrical and Electronics Engineers (IEEE) 802.11 DLS service.

The WLAN system includes one or more basic service set (BSS). The BSS is a set of STAs that may be successfully synchronized to communicate with each other and thus, does not include a concept indicating a specific domain.

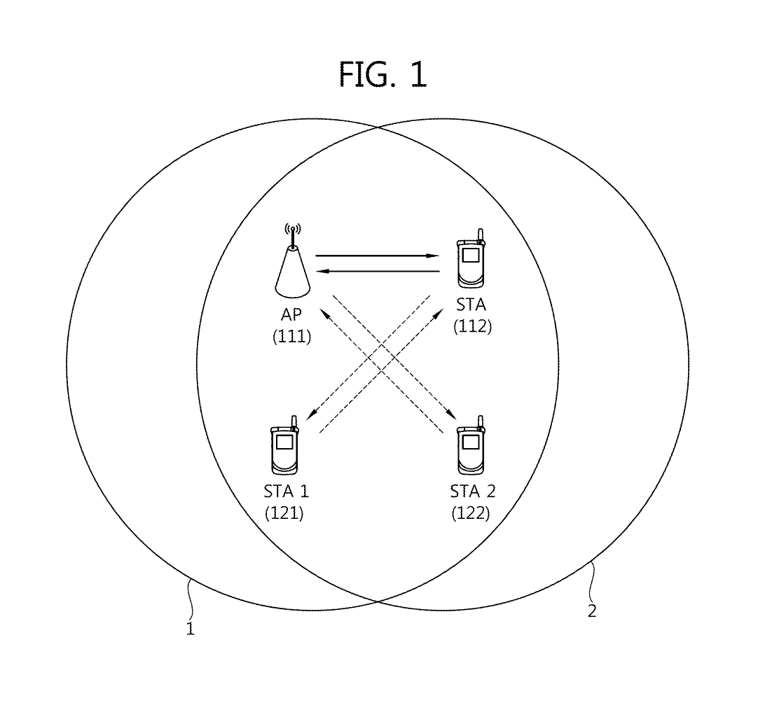

The BSS includes a concept of an infrastructure BSS and an independent BSS (IBSS). FIG. 1 shows the infrastructure BSS.

The infrastructure BSSs (BSS1 and BSS2) include more than one STAs (STA, STA1, and STA2), an access point (AP) that is the STA providing a distribution service, and a distribution system (DS) connecting a plurality of APs. On the other hand, since the IBSS does not include the AP, all the STAs are configured of a mobile station and do not access the DS and thus, constitute a self-contained network.

The STA includes a medium access control (MAC) according to IEEE 802.11 standard and includes both of the AP and non-AP station, in a broad sense, as any function medium including a physical layer interface for a wireless medium. Further, the STA including a transceiver operated at a band of 60 GHz is referred to as a mmWave STA (mSTA).

The STA for wireless communication may include a processor and a transceiver and may include a user interface unit, a display unit, or the like. The processor, which is a function unit devised to generate the frame to be transmitted through the wireless network or process the frame received through the wireless network, serves to several functions for controlling the STA. Further, the transceiver is a devised unit that is functionally connected with the processor and transmits and receives the frame through the wireless network for the station.

The portable terminal operated by the user among the STAs, which is a non-AP STA, is referred to as the non-AP STA when being simply referred to STA hereinafter. The non-AP STA may be referred to as other names such as a terminal, a wireless transmit/receive unit (WTRU), a user equipment (UE), a mobile station (MS), a mobile terminal, a mobile subscriber unit, or the like.

The AP is a functional entity that provides an access to DS via a wireless medium for the STA associated therewith. In the infrastructure BSS including the AP, communication among the STAs may be basically performed via the AP, but may be directly performed among the STAs when direct links are established. The AP may be referred to as the access point but may also be referred to as a centralized controller, a base station (BS), a node-B, base transceiver system (BTS), or a site controller, or the like.

In the WLAN system, the AP and/or STA is based on the wireless resources for transmitting frames, that is, carrier sensing multiple access-collision avoidance (CSMA-CA) protocol at the time of using the channel. When the specific AP and/or the STA occupy the wireless resources, other terminals therearound cannot access the channels and thus, cannot use the channels. In this condition, the AP and/or the STA can access the channel based on the contention based access service so as to occupy the channel for transmitting the frame. A detailed specification associated with the channel access of the AP and/or the STA may be referred to section 9 of ‘IEEE Standard for Information technology—Telecommunications and information exchange between systems—Local and metropolitan area networks—Specific requirements, Part 11 Wireless LAN Medium Access Control (MAC) and Physical Layer (PHY) Specifications’.

However, even though the channel is occupied by the AP and/or the STA, other STAs may transmit and receive the frame using the corresponding channel when other STAs do not cause the interference with the transmission and reception of frame conventionally performed. In more detail, when a beam is appropriately formed by the MIMO, it is possible to separately transmit and receive a frame without causing the interference with the conventional transmission and reception of frame. Hereinafter, a method for transmitting and receiving a frame without causing interference in the existing AP and STA.

FIG. 1 is a diagram showing an example of a WLAN system. An STA, an STA1, and an STA2 are disposed in a transmitting domain 1 of an AP and the AP, the STA1, and the STA2 are disposed in a transmitting domain 2 of the STA.

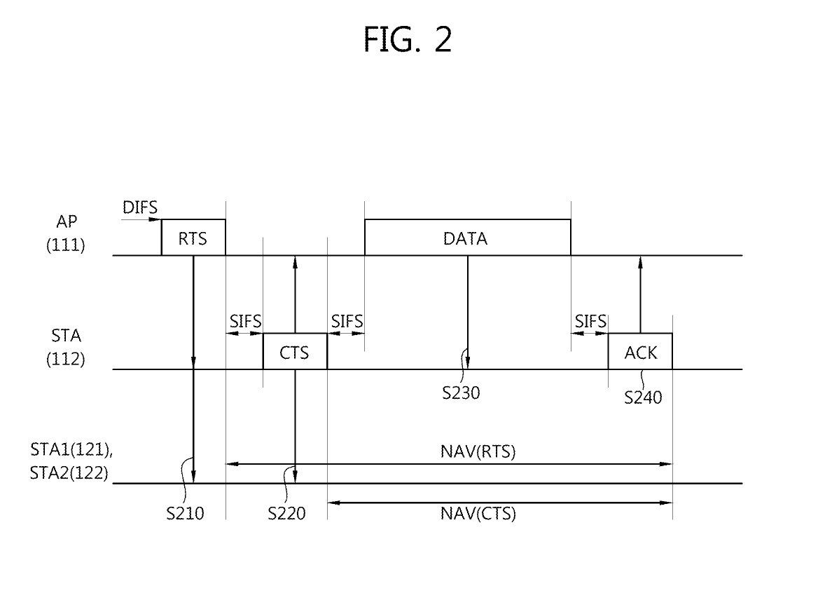

Referring to FIG. 1, an AP 111 and an STA 112 occupy a channel to transmit and receive data. According to an MAC protocol of the IEEE 802.11 standard, the AP 111 and the STA 112 occupy a channel for transmitting and receiving data, wherein the channel occupancy may be performed by transmitting and receiving a request to send (RTS) frame and a clear to send (CTS) frame. Thereby, other STAs (STA1 121 and STA2 122) existing in the transmitting domain of a transmitting end side transmitting the RTS frame may be set with a network allocation vector (NAV) so as not to use a channel until the data transmission at the transmitting end ends. Similarly, other STAs (STA1 121 and STA2 122) existing in the transmitting domain of a receiving end transmitting the CTS frame may be set with the NAV so as not to use the channel. As such, a method for transmitting and receiving the RTS frame/CTS frame will be described in more detail with reference to FIG. 2.

FIG. 2 is a message flow chart showing the transmission and reception of the RTS-CTS frame. Although FIG. 2 shows that the AP 111 transmits the RTS frame to the STA 112, but the exemplary embodiment of the present invention is not limited thereto. Therefore, the STA 112 may transmit the RTS frame to the AP 111.

Referring to FIG. 2, the AP 111 intending to transmit the data frame waits for interframe spacing (IFS) that is a specific interval for accessing a channel and then occupies the channel to transmit the RTS frame to the STA 112 (S210). The IFS that is a waiting interval for transmitting the RTS frame may be distributed coordination function (DCF) interframe spacing (DIFS) that is a minimum non-using period of a medium in a contention based service. The RTS frame may include the NAV indicating a channel occupying interval required to allow the AP 111 to transmit data.

The STA 112 receiving the RTS frame transmits the CTS frame as a response to the RTS frame to the AP 111 (S220). The STA 111 may wait for as much as the IFS at the time of receiving the RTS frame so as to transmit the CTS frame and then, transmit the CTS frame. The waiting interval for transmitting the CTS frame may be a short IFS (SIFS) that is a waiting interval for transmitting the frame having highest priority. The CTS frame may also include the NAV indicating the channel occupying interval required to allow the AP 111 to transmit data. However, the NAV included in the CTS frame may indicate a shorter interval than the NAV included in the RTS frame. The reason is that there is a difference in a temporal interval consumed to transmit the CTS frame after receiving the RTS frame.

Therefore, when the STA1 121 and the STA2 122 disposed in the transmitting domain of the AP 111 receives or overhears the RTS frame and/or the CTS frame, they are in a waiting state without attempting the channel for a period indicated by the NAV included in the RTS frame and/or the CTS frame.

As described above, when the NAV is set, the AP 111 may wait for as much as the IFS after receiving the CTS frame and transmit the data frame (S230) and the STA 112 may transmit to the AP 111 an acknowledgement frame (ACK frame) indicating that the data frame is normally transmitted (S240). The waiting period at the time of transmitting the data frame of the AP 111 and the waiting period at the time of transmitting the ACK frame of the STA 112 may be the SIFS. As described above, when the NAV is set through the exchange of the RTS/CTS frames, the channel access of the STA1 121 and/or the STA2 122 is limited and therefore, the AP 111 and the STA 112 may transmit and receive the data frame without interference due to the channel access of the adjacent STA1 121 and STA2 122. In this invention, we explain the estimation of interference channels in RTS frame/CTS frame exchange process.

However, other kinds of frame exchange procedures can be used. In details, NDP (Null Data Packet) frame/Very High Throughput (VHT) Compressed Beamforming frame exchange in IEEE 802.11ac can be used for estimation of interference channels in a channel sounding procedure. The NDP frame is transmitted for initializing a channel sounding procedure. The NDP frame has a general PLCP (physical layer convergence protocol) frame format without a data field including PSDU (PLCP service data unit). That is, the NDP frame includes a short training field (STF) and at least one long training field (LTF). Therefore, the STA1 121 and/or the STA2 can estimate the interference channel based on the NDP.

The VHT Compressed Beamforming frame is transmitted as response to the NDP frame and includes modulation and coding scheme (MCS) feedback information. Like the NDP frame, the VHT Compressed Beamforming frame has a STF and at least one of LTF. Therefore, the STA1 121 and/or the STA2 can estimate the interference channel based on the VHT Compressed Beamforming frame. VHT Compressed Beamforming frame may be referred as a feedback frame.

Referring again to FIG. 1, the STA1 121 and the STA2 122 cannot access and use the channel while the AP 111 and the STA 112 normally occupy the channel to transmit and receive data. However, when the STA may use the channel without affecting the transmission and reception of frame of the AP 111 and the STA 112, the use limitation of the channel for the peripheral terminals may be removed. In detail, when the transmitting signal of the peripheral STA such as the STA1 121 and the STA2 122 does not affect the AP 111 and/or the STA 112 reserving the channel use through the RTS/CTS frame exchange, or the like, or occupying and using the channel in advance, the transmission and reception of the data frame between the AP 111 and/or the STA 112 and the transmission and reception of data frame between the peripheral STAs may be simultaneously performed. That is, when the STA1 121 and the STA2 122 having a MIMO use the beamforming mechanism so that the transmitting signal does not reach a receiving end or only very slight interference is caused during the process of transmitting and receiving data between the AP 111 and/or the STA 112, the process of transmitting and receiving two data frames may be simultaneously performed. In addition, when the interference due to the transmitting signal of the transmitting end during the process of transmitting and receiving data between the AP 111 and/or the STA 112 is removed by the beam forming mechanism at the receiving side of the STA1 121 and the STA2 122, the STA1 121 and the STA2 122 may transmit and receive the data frame. Hereinafter, so as not to affect the transmission and reception of the data frame between other APs and/or STAs reserving the channel occupancy or used in advance under the condition in which the STA having a MIMO does not obtain the channel access authority, a method and an apparatus for transmitting and receiving a frame are proposed by obtaining an independent spatial domain by the beam forming mechanism.

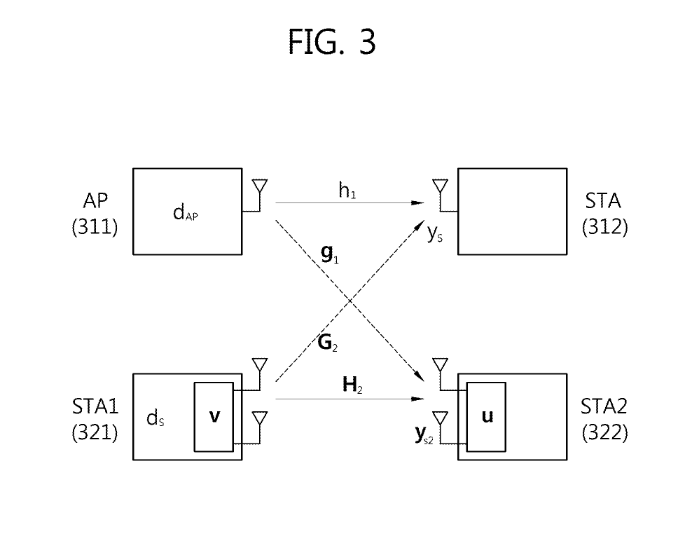

FIG. 3 is a diagram showing an example of the WLAN system that may be applied to the exemplary embodiment of the present invention.

Referring to FIG. 3, an AP 311 accesses the channel to transmit the data frame to an STA 312. An STA1 321 and an STA2 322 are the STAs disposed in the transmitting domain of the AP 311 and/or the STA 312 and are the STA intending to transmit and receive the independent data frame. FIG. 3 assumes the condition in which the STA1 321 intends to transmit the data frame to the STA2 322.

The AP 311 and the STA 312 each have a single antenna to transmit and receive the data frame. The STA1 321 and the STA2 322 each have the MIMO and independently transmit and receive the data frame using the same. FIG. 3 shows that the STA1 321 and the STA2 322 have two antennas, but if the number of antennas meets the beamforming condition, the number of antennas is not particularly limited. In addition, it is assumed that that the STA can know channel coefficients by using a reciprocal characteristic of a wireless channel, which means that one channel is used as a forward channel from transmitting end to a receiving end and a reverse channel from a receiving end to a transmitting end are the same. In the drawings, a regular letter means a scalar, a bold small letter means a column vector, and a bold capital means a matrix parameter.

The transmitting signal of the AP 311 is set to be d_{AP}, a channel gain between the AP 311 and the STA 312 is set to be h₁, and the receiving signal of the STA 312 is set to be yₛ. An interference channel gain due to the interference of the transmitting signal from the AP 311 to the STA 312 affecting the STA 322 is set to be g₁. A transmitting signal of the STA 321 is set to be dₛ, a transmitting beam vector for the STA1 321 to transmit MIMO is set to be v, a channel gain between the STA1 321 and the STA2 322 is set to be H₂, and an interference channel gain due to the interference of the transmitting signal of the STA1 321 affecting the STA 312 is set to be G₂. The receiving signal of the STA2 322 is set to be yₛ₂ and the receiving beam vector of the STA2 322 is set to be u. In this case, the receiving signal at the STA 321 may be represented by the following Equation 1.

yₛ=h₁d_{AP}+G₂vdₛ+n [Equation 1]

Here, n represents a receiving noise. A first term from the right of Equation 1 represents a transmitting signal to be transmitted from the AP 311 to the STA 312 and a second term from the right of Equation 1 represents interference due to the transmission of the STA1 321. Therefore, in order that the AP 311 and/or the STA 312 having the right of using a channel is not interfered by the STA1 321 and/or the STA2 322, it should satisfy conditions of the following Equation 2 when the transmitting beam vector of the STA1 321 is set.

G₂v=0 [Equation 2]

That is, the transmitting beam vector v is enough to exist in a null space of the G₂ that is the interference channel matrix due to the STA1 321.

Further, the yₛ₂ that is the receiving signal of the STA 2 322 may be represented by the following Equation 3.

yₛ₂=H₂vdₛ+g₁d_{AP}+n[Equation 3]

Here, n represents the receiving noise acting on the STA2 322. Further, it may be represented by the following Equation 4 by multiplying the receiving beam vector u by the receiving signal.

u^{H}yₛ₂=u^{H}H₂vdₛ+u^{H}g₁d_{AP}+u^{H}n [Equation 4]

Where x^{H} represents an operation of a complex vector represented by x or a complex conjugate transpose of a matrix. A first term from the right of Equation 4 represents a transmitting signal to be transmitted from the STA1 321 to the STA2 322 and a second term from the right of Equation 4 represents interference due to the transmission of the AP 311. Therefore, in order for the STA1 321 and the STA2 322 to independently transmit and receive the data frame without interfering with the AP 311 and/or the STA 312, the receiving beam vector of the STA2 322 should satisfy conditions of the following Equation 5.

u^{H}g₁=0 or g₁^{H}u=0 [Equation 5]

That is, the receiving beam vector u is enough to exist in a null space of the complex conjugate transpose g₁^{H} of the interference channel matrix.

As described above, when the transmitting beam vector v of the STA1 321 and the receiving beam vector u of the STA2 322 are set, the transmission and reception of the data frame between the AP 311 and the STA 312 occupying the channel and the transmission and reception of the data frame between the STA1 321 and the STA2 322 may coexist without interfering with each other.

As described above, there is a need to obtain the interference channel information such as the G₂ and the g₁^{H} in order to determine the transmitting beam vector and the receiving beam vector. This may use the reciprocal characteristics of the wireless channel. That is, as shown in FIG. 2, the interference channel information associated with the g₁ can be obtained at the time of demodulating the RTS frame by the STA2 322 while the AP 311 and/or the STA 312 exchange the RTS/CTS frames to occupy the channel. Therefore, the STA2 322 can obtain the receiving beam vector u used to receive the data frame transmitted from the STA1 321 by using the same so as to satisfy Equation 5. Similarly, the STA1 321 may estimate the channel matrix G₂ during the process of receiving the CTS frame transmitted by the STA 312 and obtain the transmitting beam vector v by using the same.

In addition to the RTS/CTS frames, the STA1 321 and the STA2 322 can obtain the transmitting and receiving beam vectors through the frame demodulation and the channel estimation by the data frame transmitted by the AP 311 and the ACK frame transmitted by the STA 312 corresponding thereto.

As described above, the STA1 321 and the STA2 322 can obtain the transmitting and receiving beam vectors during the process of exchanging the RTS/CTS frame. Further, the STA1 321 and the STA2 322 can confirm the temporal period in which the data frame is transmitted between the AP 311 and/or the STA 312 by referring to the NAV set by the RTS/CTS frames to perform the transmission and reception of the data frame based on the transmitting and receiving beam vectors for the corresponding period. When the STA1 321 transmits the data frame to the STA2 322 based on the transmitting beam vector, the interference may not be caused at the time of the reception of the STA and the wireless signal transmitted from the AP 311 may not act as the interference based on the receiving beam vector of the STA2 322. As a result, the independent transmission and reception of the data frame between the STA1 321 and the STA2 322 may be considered as communication through an effective channel that may be represented by u^{H}H₂v.

When the reciprocal characteristic of the wireless channel is not secured under the WLAN system environment, the STA1 321 and/or the STA2 322 may not obtain the transmitting and receiving beam vectors even though they obtains the channel information by demodulating the RTS/CTS frames and/or performing the channel estimation based on the RTS/CTS frames. Therefore, the RTS frame includes the interference channel information associated with the g₁ and the CTS frame includes the interference channel information associated with the G₂ under the WLAN system environment and the STA1 321 and the STA2 322 can directly obtain the corresponding interference channel information through the RTS/CTS frames.

As an example of the WLAN system of FIG. 3, the AP 311-the STA 312 and the STA1 321-the STA2 322 transmit one data stream to each other. That is, a total number of data frames transmitted through two links is 2. Further, the number of antennas of the STA1 321 and the STA2 322 is equal to 2 that is a total number of data streams. When a total number of data streams of two links are equal to or less than the number of antennas of the STA1 and the STA2, the transmitting and receiving beams satisfying Equations 2 to 5 may be designed. Therefore, the configuration of the system may be changed in the range of satisfying the above conditions.

Although the WLAN system environment is described up to now, the exemplary embodiment of the present invention can be applied to a terminal communication system based on time division duplex (TDD). That is, the AP is referred to as a base station (BS) and the STA, the STA1, and the STA2 may be referred to as a mobile station (MS), an MS1, and an MS2. Hereinafter, this will be described with reference to the drawings.

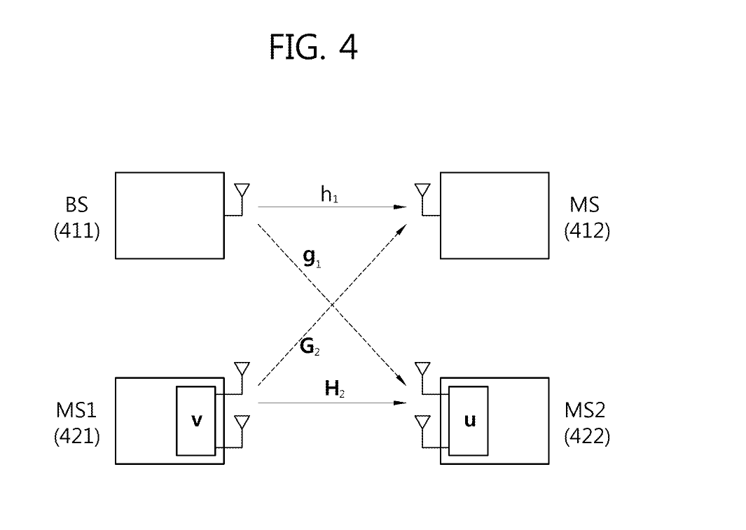

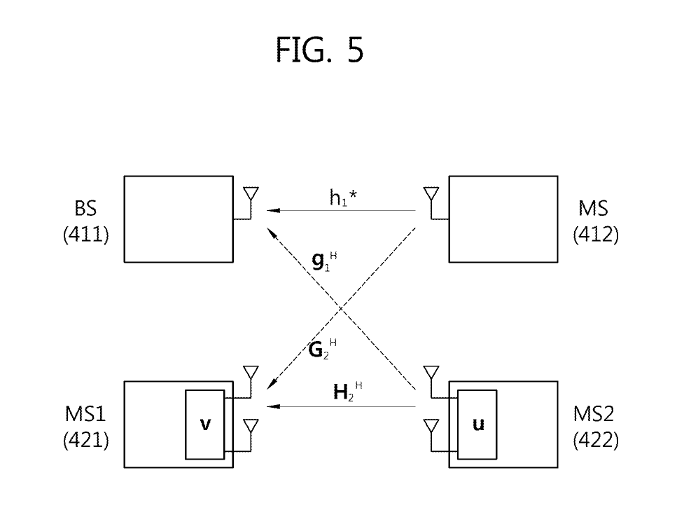

FIGS. 4 and 5 are diagrams showing an example of a communication system to which the exemplary embodiment of the present invention can be applied. It is assumed that four nodes of the BS, the MS, the MS1, and the MS2 are synchronized with one another.

FIG. 4 is a diagram showing an example of the communication system performing a downlink operation to which the exemplary embodiment of the present invention can be applied. h₁ of FIG. 4 is represented by the channel gain at the time of transmitting data from a BS 411 to an MS 412 and g₁ is a channel vector associated with the interference of the wireless signal of the BS 411 affecting an MS2 422. H₂ represents the corresponding channel gain at the time of transmitting data to the MS2 422 and G₂ is a channel matrix associated with the interference of the MS 1 421 affecting the MS 412. v represents the transmitting beam vector of the MS1 421 and u represents the receiving beam vector of the MS2 422.

FIG. 5 is a diagram showing the communication system performing an uplink operation to which the exemplary embodiment of the present invention can be applied. h₁* of FIG. 5 means the channel gain at the time of transmitting data from the MS 412 to the BS 411 and ‘*’ means the complex conjugate operation of the complex scalar. g₁^{H} represents the channel vector associated with the transmitting interference of the wireless signal of the MS2 422 affecting the BS 411. H₂^{H} represents the corresponding channel gain at the time of transmitting data from the MS2 422 to the MS 1 421 and G₂^{H} is a channel matrix associated with the interference of the MS 412 affecting the MS1 421. v represents the receiving beam vector of the MS1 421 and u represents the transmitting beam vector of the MS2 422. ‘^{H}’ represents the operation of the complex vector or the complex conjugate transpose of the matrix.

It is assumed that as shown in FIG. 4, the MS1 421 transmits data to the MS2 422 for a period operated as the downlink, that is, a period in which the BS 411 transmits data to the MS 412 and as shown in FIG. 5, the MS2 422 transmits data to the MS 421 for a period operated as the uplink, that is, a period in which the MS 412 transmits data to the BS 411. More general conditions will be described with reference to the following Table 1.

TABLE 1

| (A) | (B) | (C) | (D) |
|---|---|---|---|
| Uplink | Downlink | Uplink | Downlink |
| Transmission | Transmission | Transmission | Transmission |
| (MS → BS) | (BS → MS) | (MS → BS) | (BS → MS) |
| | P2P Transmission | P2P Transmission | |
| | (MS1 → MS2) | (MS2 → MS1) | |

The following Table 1 is a table representing a condition of the data communication according to the link between the BS 411-the MS 412 and the data communication according to the link between the MS1 421-the MS2 422. Referring to Table 1, the P2P data communication may be performed to proceed from the MS1 421 to the MS2 422 at the time of the downlink transmission as shown by (B) and (C) and the P2P data communication may be performed to proceed from the MS2 422 to the MS1 421 at the time of the uplink transmission. However, the downlink/uplink transmission is performed as shown by (A) and (D), but the data communication between the MS1 421 and the MS2 422 may not be performed.

When the downlink/uplink transmission is continuously repeated and the change in the wireless channel is negligible, the channel gains of the downlink and the uplink may both have the complex conjugate transpose form to maintain the same transmitting and receiving beam vectors. In other words, v used as the transmitting beam vector for the downlink transmission period in the MS 1 421 may be used as the receiving beam vector in the continued uplink period. This can be appreciated through a beam vector calculation condition as shown in Equations 2 and 5. First, the transmitting beam vector in the downlink period needs to satisfy the condition of G₂v=0 and the receiving beam vector in the uplink period needs to satisfy V^{H}G₂^{H}=0. Therefore, it can be appreciated that the transmitting beam vector in the downlink period to be used by the MS 1 421 is equal to the receiving beam vector in the uplink period. According to the same logic, it can be appreciated that the transmitting beam vector of the MS2 is equal to the receiving beam vector. Therefore, it is simpler to obtain the transmitting and receiving beam vectors under the TDD terminal communication environment.

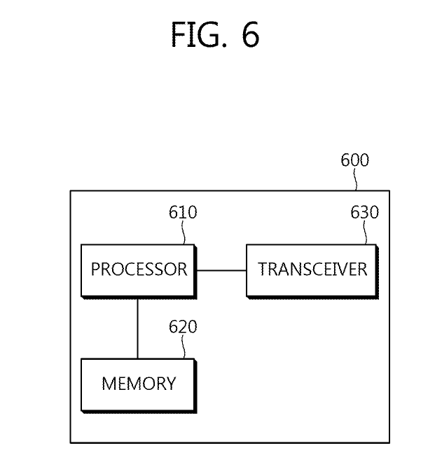

FIG. 6 is a block diagram showing a wireless device to which the embodiment of the present invention may be applied. A wireless apparatus 600 may be an AP, a non-AP station, a BS, or an MS.

The wireless apparatus 600 includes a processor 610, a memory 620, and a transceiver 630. The transceiver 630 transmits and/or receives wireless signals. The transceiver 630 may implement a physical layer (PHY) of the IEEE 802.11 in the WLAN system. The processor 610 is functionally connected with the transceiver 630 and may implement the exemplary embodiment of the present invention shown in FIGS. 1 to 5. The processor 610 may implement an MAC layer of the IEEE 802.11 when being applied to the WLAN system.

The processor 610 and/or the transceiver 630 may include an application-specific integrated circuit (ASIC), other chip sets, a logical circuit and/or a data processing device. The memory may include a read-only memory (ROM), a random access memory (RAM), a flash memory, a memory card, a storage medium, and/or other storage apparatus. When the exemplary embodiments of the present invention are implemented by software, the above-mentioned methods may be implemented by a module (process, function, or the like) performing the above-mentioned functions. The module is stored in the memory 620 and may be executed by the processor 610. The memory 620 may be included inside the processor 610 and may be separately disposed outside the processor and be functionally connected to the processor 610 by widely known various units.

The exemplary embodiments of the present invention can provide a method for transmitting and receiving a frame using a co-channel without causing the interference in the STA accessing the channel to transmit and receive a frame by transmitting the data frame based on the multiple input multiple output (MIMO) transmission. Therefore, the STAs can access the wireless channel by the method to improve the throughput of the entire WLAN system and improve the use efficiency of the wireless resources.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A method for transmitting a frame in a wireless local area network (WLAN) system, comprising:
obtaining, by a station (STA), interference channel information of an interference channel between the STA and a neighbor STA that is a frame transmission target STA of an access point (AP);
determining, by the STA, a transmitting beam vector based on the interference channel information; and
transmitting, by the STA, a data frame to a transmission target STA using a multiple input multiple output (MIMO) transmission based on the transmitting beam vector.

2. The method of claim 1, wherein the step of the obtaining the interference channel information between the STA and the neighbor STA includes:
receiving, by the STA, a clear to send frame (CTS) frame, from the neighbor STA, the CTS frame being transmitted from the neighbor STA to the AP for informing the AP that the neighbor STA is ready to receive a frame; and
estimating, by the STA, the interference channel based on the received CTS frame.

3. The method of claim 2, wherein the interference channel information includes an interference channel matrix G₂ that is a result of estimating the interference channel, and
the interference channel matrix G₂ satisfies the following Equation.
G₂v=0 (where v is the transmitting beam vector).

4. The method of claim 1, wherein the step of the obtaining the interference channel information between the neighbor STA and the STA includes:
receiving, by the STA, an acknowledgement frame (ACK frame) from the neighbor STA, the ACK frame being transmitted as a response to a frame transmitted by the AP; and
estimating, by the STA, the interference channel based on the ACK frame.

5. The method of claim 4, wherein the interference channel information includes an interference channel matrix G₂ that is a result of estimating the interference channel, and
the interference channel matrix G₂ satisfies the following Equation.
G₂v=0 (where v is the transmitting beam vector).

6. The method of claim 1, wherein the step of the obtaining the interference channel information include:
receiving, by the STA, a feedback frame from the neighbor STA, the feedback frame including modulation and coding scheme (MCS) feedback information according to a channel sounding; and,
estimating, by the STA, the interference channel information based on the feedback frame.

7. The method of claim 1, wherein if a reciprocal characteristic of a channel of the WLAN system is not supported, the step of the obtaining the interference channel information includes;
receiving, by the STA, the interference channel information transmitted in a CTS frame.

8. A method for receiving a frame in a WLAN system, comprising:
obtaining, by a station (STA), interference channel information of an interference channel between an AP and the STA;
determining, by the STA, a receiving beam vector based on the interference channel information; and
receiving, by the STA, a data frame transmitted from a transmitting STA, the data frame being transmitted through MIMO transmission,
wherein the step of receiving the data frame includes applying beam vector to a wireless signal received by the STA.

9. The method of claim 8, wherein the step of the obtaining the interference channel information between the AP and the STA includes:
receiving, by the STA, a request to send frame (RTS frame) from the AP, the RTS frame being transmitted for informing that the AP accesses a channel to transmit a frame; and
estimating, by the STA, the interference channel based on the RTS frame.

10. The method of claim 9, wherein the interference channel information includes an interference channel matrix g₁ that is a result of estimating the interference channel, and
the interference channel matrix g₁ satisfies the following Equation.
u^{H}g₁=0 (wherein u is the receiving beam vector and u^{H} is a vector obtained by performing complex conjugate transpose on the u).

11. The method of claim 8, wherein the step of the obtaining the interference channel information between the AP and the STA includes:
receiving, by the STA, a frame from the AP, the frame being transmitted from the AP to the neighbor STA, the neighbor STA being a transmission target STA of the AP; and
estimating, by the STA, the interference channel based on the frame.

12. The method of claim 11, wherein the interference channel information includes an interference channel matrix g₁ that is a result of estimating the interference channel, and
the interference channel matrix g₁ satisfies the following Equation.
u^{H}g₁=0 (where u is the receiving beam vector and u^{H} is a vector obtained by performing complex conjugate transpose on the u).

13. The method of claim 8, wherein the step of the obtaining the interference channel information between the AP and the STA includes:
receiving, by the STA, a null data packet (NDP) frame from the AP, the NDP frame being transmitted for initializing a channel sounding procedure; and
estimating, by the STA, the interference channel based on the NDP frame.

14. The method of claim 8, wherein if a characteristic of a channel of the WLAN system is not supported, the step of obtaining the interference channel information includes;
receiving, by the STA, the interference channel information transmitted in a RTS frame.

15. A wireless apparatus, comprising:
a processor; and
a transceiver operatively connected with the processor to transmit and receive a frame, wherein the processor is configured for:
obtaining interference channel information of an interference channel between the STA and neighbor STA that is a frame transmission object of an access point (AP);
determining a transmitting beam vector based on the interference channel information; and
transmitting a data frame to a transmission target STA using a multiple input multiple output (MIMO) transmission based on the transmitting beam vector.

16. The wireless apparatus of claim 15, wherein the obtaining the interference channel information includes:
receiving a clear to send frame (CTS) frame, from the neighbor STA, the CTS frame being transmitted from the neighbor STA to the AP for informing the AP that the neighbor STA is ready to receive a frame; and
estimating the interference channel based on the received CTS frame.

17. The wireless apparatus of claim 16, wherein the interference channel information includes an interference channel matrix G₂ that is a result of estimating the interference channel, and
the interference channel matrix G₂ satisfies the following Equation.
G₂v=0 (where v is the transmitting beam vector).

18. The wireless apparatus of claim 15, wherein the obtaining the interference channel information includes:
receiving, by the STA, an acknowledgement frame (ACK frame) from the neighbor STA, the ACK frame being transmitted as a response to a frame transmitted by the AP; and
estimating, by the STA, the interference channel based on the ACK frame.

19. The wireless apparatus of claim 18, wherein the interference channel information includes an interference channel matrix G₂ that is a result of estimating the interference channel, and
the interference channel matrix G₂ satisfies the following Equation.
G₂v=0 (where v is the transmitting beam vector).
